(19) United States
(12) Patent Application Publication
(10) Pub. No.: US 2014/0250386 A1
(43) Pub. Date: Sep. 4, 2014

(54) METHOD AND SYSTEM FOR CLIENT SIDE USER INTERFACE GENERATION

(71) Applicant: Daniel Schick, Schorndorf (DE)

(72) Inventor: Daniel Schick, Schorndorf (DE)

(73) Assignee: AUDIUS GMBH, Weinstadt (DE)

(21) Appl. No.: 14/349,497

(22) PCT Filed: Oct. 4, 2011
(86) PCT No.: PCT/EP2011/067261

§ 371 Date: Apr. 3, 2014

(51) Int. Cl. G06F 3/048

(52) U.S. Cl. CPC G06F 3/048
USPC 715/744

(57) ABSTRACT

A computer implemented method, system and computer program product for graphical user interface generation at a client. The client receives an abstract user interface description from at least one server. The abstract user interface description is mapped to at least one executable client specific layout component. A client specific user interface is generated by instantiating the at least one executable client specific layout component. The client receives application data from the at least one server, wherein the application data is associated with the at least one executable client specific layout component. Thereby the application data is separate from the abstract user interface description. The client specific user interface is then merged with the associated application data.

### TECHNICAL FIELD

The present invention generally relates to electronic data processing, and more particularly, relates to methods, computer program products and systems for user interface generation.

### BACKGROUND

Software applications are often executed on a client computer, which is remotely and communicatively coupled to a server computer. Typically data and user interface layout information is stored on the server. When a client requests to execute an application, the server generates a corresponding client specific graphical user interface description and transmits this description to the client. Thereby, the application data is included in the user interface description. The client can then visualize the client specific user interface, for example, through the browser on the client.

Because the user interface is generated with each client request to include the currently requested data, the whole interface description needs to be transferred to the client for each request. Some approaches allow for so called delta rendering, where only modified parts of the user interface description are regenerated and transmitted to the client. Still, the server has to generate the client specific delta description including data changes. Because of resending redundant layout information again and again to the client, bandwidth is wasted for duplicate information transmission.

Further, the server has to know all client specific representations of various layout components that are used in the application. This is challenging especially in the context of mobile clients. Many different operating systems support many different mobile client devices having different device specific constraints. For example, a smartphone may have a larger display with better resolution than a traditional mobile phone but a smaller display than a tablet PC. The user of the respective client needs an application layout that fits the respective device constraints of the client to achieve optimal interaction with the application. To satisfy this need the server always needs to know about all possible available mobile devices, which may send a corresponding request to the server.

Further, the use of the application at the client always requires a new request to the server to and a corresponding response from the server whenever the client wants to execute the application. Thus, an offline mode for the client, which allows the client to run the application without interacting with the server, is not possible.

### SUMMARY

Therefore, there is a need to improve user interface generation for applications executed by a client to avoid resubmission of redundant data for reducing bandwidth requirements in the communication between client and server and, at the same time, to allow any possible client device to interact with the server without a need of server side modifications while still preserving the capability of generating the user interface in a way which is optimal for the respective client.

The problem is solved by aspects of the invention according to claims 1, 11 and 12 where the server provides an abstract user interface description to the client void of any application data. The application data is transmitted separately and the client generates a client specific user interface which respects all constraints of the client device and which merges the application data with the client specific user interface.

In one aspect of the invention a computer implemented method enables graphical user interface generation at a client.

The client receives from at least one server an abstract user interface description for a certain application. Such an abstract user interface description information about the structure of the graphical user interface. Typically an application includes multiple different views on application data which allow the user to navigate and interact with the various views. Structural elements of such an application user interface can be masks, wherein the application can be designed by a sequence of various masks presented to a user of client in response to the user's interaction with the application. A mask again may include various abstract layout components. An abstract layout component is a layout component, which does not include any device specific information, which could prevent the abstract layout component from being usable on any client device. Grouping objects may be used to define the sequential order of the abstract layout components. Further the abstract user interface description may include various properties for defining the visual appearance of the abstract layout components once being displayed on a client device. Further, the abstract user interface description may include a hierarchy which is suitable to define the sequential order of masks and a navigation scheme for defining the interaction options of the user with the application. Further, the abstract user interface description may include information about application data being associated with which respective layout components. For example, this can be achieved by including corresponding object definitions for data objects, such as data field references related to an abstract layout component.

The client can then perform a mapping operation, where the abstract user interface description is mapped to at least one executable client specific layout component. Such executable client specific layout components may be stored in a corresponding client specific layout component library of the client, which includes all potential client specific layout components being executable on the respective client. Typically such executable layout components are designed by taking into account all client device specific constraints, such as display size, display resolution, etc., to enable optimal look and feel and performance for the application when being executed of this client device.

The client can then instantiate the at least one executable client specific layout component to generate a client specific user interface of the application. The generation may require instantiations of multiple client specific layout components depending on the structure defined by the abstract user interface description. The client specific user interface of the application becomes visible to the user and the user can start to interact with the application. However, application data may not yet be available after this initialization phase. An advantage of this feature is that the optimal client specific user interface is solely created by the client device itself on the basis of the abstract user interface description. The server does not even need to know about the various client devices, which may consume the application. As a consequence, there is no need to store layout component libraries of hundreds of different client devices at the server. Especially with mobile clients becoming omnipresent this avoids the tedious and error prone task to update all the time all kinds of different client device specific libraries on a server. Instead, each client device is responsible on its own to interpret the abstract user interface description in a way that application is presented to the user in an optimal device specific manner.

The client may then receive application data from the at least one server. The application data is arriving separately from the abstract user interface description. That is, the abstract user interface description does not include any application data. References to data object types can be part of the abstract user interface description. The application data is associated with the at least one executable client specific layout component. This association is defined in the abstract user interface description, for example by using the data object types.

The client can then merge the client specific user interface with the associated application. This may be achieved by storing the application data at a memory location, which is used by a data field reference in an instance of an executable client side specific layout component. An advantage of this feature is that the application data can be updated any time without a need to modify the client specific user interface at all. It is sufficient to only transfer the layout information once during the initialization phase. Resubmission of redundant layout data can be avoided and less bandwidth is consumed.

In another aspect of the invention a client computer includes all components, which are required to execute the above method. Such components may be:

An interface component, which is configured to receive the abstract user interface description and further configured to separately receive the application data being associated with at least one executable client specific layout component. Separate receipt of application data means that the data is physically separated. They may still arrive substantially simultaneously at the client.

At least one memory component can store the client specific user interface component library. This library may include the complete set of client specific layout components needed for composing an application in accordance with the abstract user interface description.

At least one processor component of the client is able to map the abstract user interface description to at least one executable client specific layout component. That is, the processor is able to identify the executable client specific layout components needed for composing the application according to the abstract user interface description. Once the executable client specific layout components are identified in the library they are instantiated by the processor component. That is, the client specific user interface of the application now becomes visible for the user on the display means of the client device. Then the processor component can merge the client specific user interface with the associated application data.

The further problem of enabling an offline mode for the client is solved by further aspects of the invention as described in claims 4 and 14, where a local application database is configured to store the application data on the client and, therefore, enables the client to run the application without connecting to the server. The advantage of this feature is enabling the client to run the application in an offline mode.

### BRIEF DESCRIPTION OF THE DRAWINGS

FIG. 1 shows a computer system according to one embodiment of the invention;

FIG. 2 is a simplified flowchart of a computer implemented method according to an embodiment of the invention;

FIG. 3 illustrates an example of a part of an abstract user interface description;

FIG. 4 illustrates a further part of the abstract user interface description;

FIG. 5 is a client specific user interface example for a iOS® client device with split controller;

FIG. 6 is a further client specific user interface example for a iOS® client device for a detailed view;

FIG. 7 is a further client specific user interface example for a HTML5 client device; and

FIG. 8 is a further client specific user interface example for a Microsoft® Windows Phone 7 client device.

### DETAILED DESCRIPTION

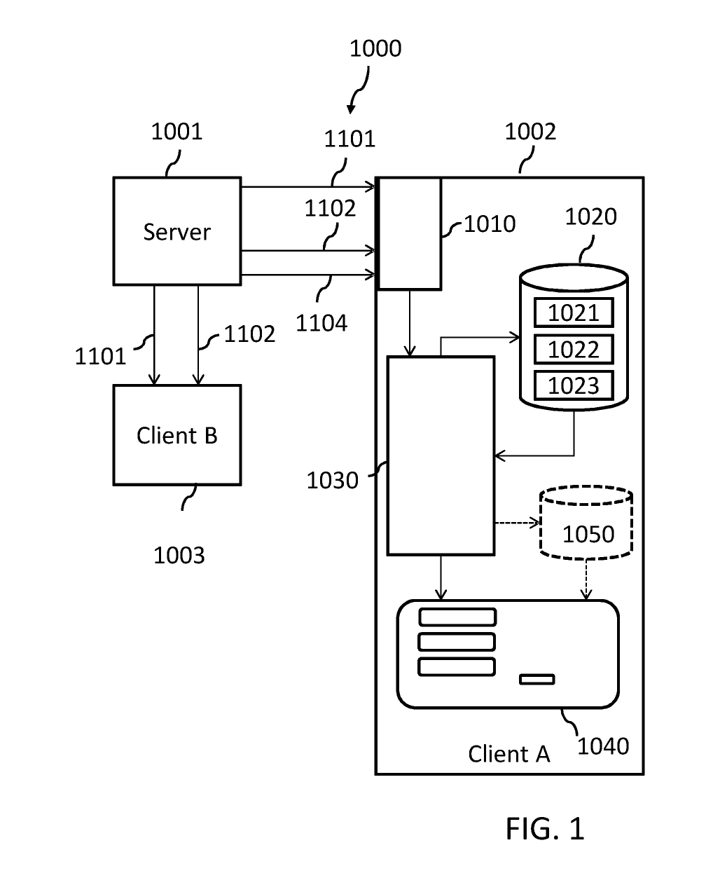

FIG. 1 shows a computer system 1000 according to one embodiment of the invention that includes one or more servers 1001 being communicatively coupled with one or more client computers 1002, 1003. The server can be an application server which is hosting applications being accessible by the client computers. Client computers can be remote PCs being connected through a wireless or a large area network. Client computers can also be mobile devices, such as smartphones, mobile phones, PDAs or tablet PCs. Such mobile device may communicate with the server through telecommunication networks as for example GSM or UMTS networks.

In the example of FIG. 1 Client A 1002 may be a different device type than client B 1003. For example, Client A can be a smartphone running on an Android® operating system, whereas

Client B may be a tablet PC operated by a Windows Mobile® operating system. The clients want to run a software application locally and therefore send a corresponding request to the server 1001. In the following only Client A will be discussed because any other client coupled to the server 1001 operates in a similar way and the person skilled in the art is able to transfer the general teaching to any other client device. In response to the request the server 1001 sends an abstract user interface description 1101 of the application and corresponding application data 1102 to the client 1002. Thereby, the application data is not included in the abstract user interface description but sent separately.

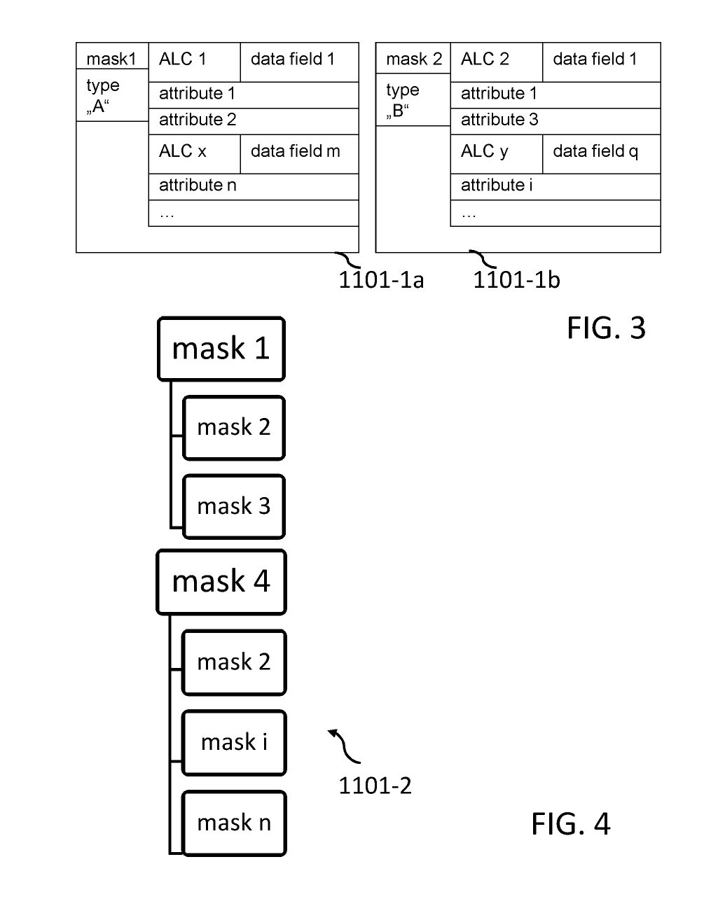

The client 1002 receives the abstract user interface description 1101 and the application data 1102 through an appropriate interface 1010. For example, the interface 1010 can be a standard web interface for web services supporting a standard request-response protocol, such as the http protocol. A processor component 1030 of the client can analyze the abstract user interface description 1101. The processor component can be any commercially available processor including multiple processors or multi-core processors. Analyzing the abstract user interface description in part means to identify the respective abstract layout components for composing the user interface of the application. The details of the abstract user interface description and its structure resolution are described under FIG. 3. One output of this initial analysis is the information about the abstract layout components (e.g., ALC 1, ALC 2, . . . , ALC y; cf. FIG. 3) included in the abstract user interface description, which are used to compose the application user interface. The processor component 1030 can then map the identified abstract layout components to corresponding executable client specific layout components 1021, 1022, 1023 stored in a memory component with a client specific user interface component library 1020. For example, as described in more details under FIG. 3, the abstract user interface description may describe the application to be executed by the client as a sequence of one or more masks with a corresponding navigation scheme. Each mask may then include one or more abstract layout components, where each layout component has an executable counterpart in the client specific user interface component library 1020. There may also be client specific layout components, which correspond to different types of masks, such as for example, a search mask, a chart mask, a result list or a details mask or any other application specific type, which would be needed.

Then the processor component can generate a client specific user interface 1040 by instantiating mapped executable client specific layout component 1021, 1022, 1023. When instantiating the client specific layout components an initialization of the content of the client specific layout components can be performed based on further information in the abstract user interface description 1101. This further information can include all kinds of attributes influencing the visual appearance of the client specific layout components. Once this initialization is done, the generated client specific interface 1040 can be displayed to the application user. For example, the client can have standard display means, such as a Liquid Crystal Display screen or any other appropriate display technology. Because the client specific user interface is composed from client specific layout components, which are optimized for the respective client device, the generated user interface automatically can be created with a look and feel which is typical for the respective client without the server having any knowledge of the client device.

At this stage the received application data 1102 is not yet visible. The application data 1102 is now merged with the client specific user interface 1040. This may be achieved through a data binding mechanism implemented in the abstract user interface description. For each abstract layout component one or more field references to application data fields can be assigned. The received application data may refer to the respective field references. The corresponding instantiated client specific layout components inherit the field references from the respective abstract layout components. By putting the application data values into memory portions, which are referenced by the field references of the client specific layout components the values are now merged into the client specific user interface and are visualized through the display means in the graphical user interface.

Although the invention is described in terms of a graphical user interface, a person skilled in the art will appreciate that the concept of the abstract user interface description can also be applied to other modalities like voice controlled interfaces or any combination thereof. For example, for a voice controlled interface a sound file could be generated instead of a graphical layout component.

One advantage of the presented concept is that in case of receiving further application data 1104 through the interface 1010, which is supposed to replace the earlier received application data 1102, there is no need to regenerate the client specific user interface 1040. The display will automatically be updated with the further application data one the data is stored at the memory portions referred by the instantiated client specific layout component 1021, 1022, 1023.

In case the client 1002 also includes a local application database 1050, the application data 1102, 1104 can be stored in this database. In this embodiment the field references of the instantiated client specific layout components can reference corresponding fields in the local application database 1050. The client can now start the application even without connecting to the server and execute the application with at least the already received and stored application data. Thus an offline mode for executing the application at the client 1002 is enabled.

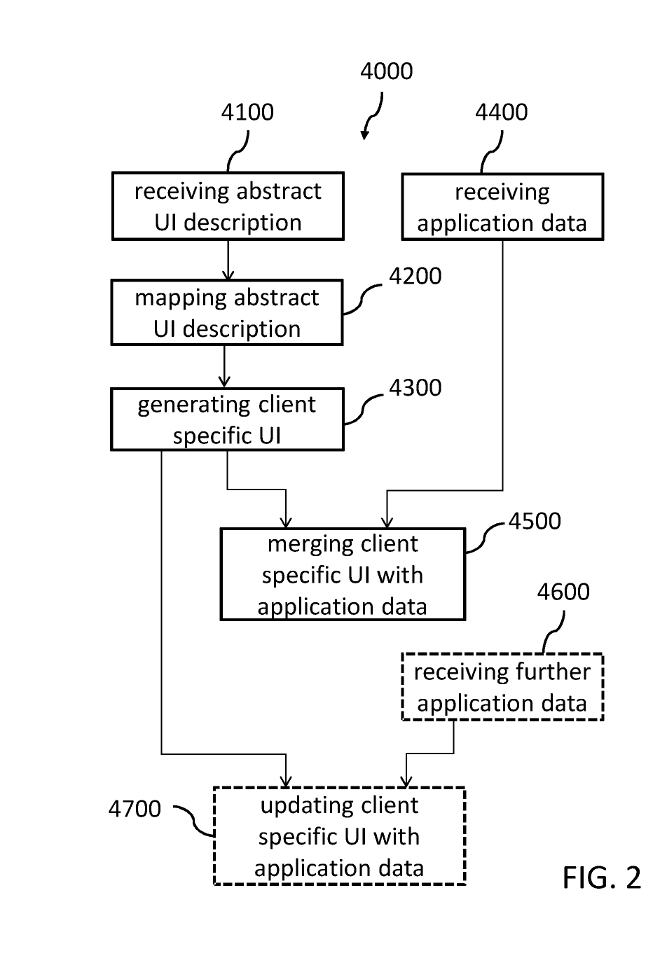

FIG. 2 is a simplified flowchart of a computer implemented method 4000 according to an embodiment of the invention. It clearly illustrates that the application data 1102, 1104 are received 4400, 4600 separately and independently from the abstract user interface description which is typically received 4100 only once at the client. This initial receipt 4100 of the abstract user interface description belongs to an initialization phase of the client specific user interface, which gets completed by mapping the elements of the abstract user interface description, namely the abstract layout components to corresponding executable client specific layout components available in the client specific runtime library 1020 of the client 1002. By instantiating those client specific components the client specific user interface is generated 4300 in accordance with other information of the abstract user interface description, such as for example, specific layout properties. The generated client specific user interface can then be displayed to the user ending the initialization phase for the client specific user interface. The application data is then merged 4500 with the generated user interface by using field references in the respective instantiated client specific layout components pointing to the received application data. Updating 4700 the client specific user interface with newly received 4600 further application data does not require repeating the user interface generation steps. Instead the further application data are simply inserted into the earlier generated client specific user interface by populating memory portions of the client, which are referenced by the respective client specific layout components. The method steps do not necessarily need to be performed in the same sequential order as shown in the flowchart. For example, the receipt of the application data can occur any time in comparison the receipt of the abstract user interface description.

FIG. 3 illustrates an example of a part of the abstract user interface description 1101. In the example the user interface to be generated should have a first mask and a second mask defined by the first mask definition 1101-1a and the second mask definition 1101-1b.

Each mask can have a type A, B. The type of the mask may correspond to the basic nature of the mask. That is, it defines whether the mask is related for example to a search function with a results table, a simple list, a details view or to any special function, such as bar or pie charts or a calendar. In the executable client specific layout component library a corresponding executable mask component may be available, which can be instantiated to reflect a layout of the mask which fits the function indicated by the type. That is, the client specific layout component library includes a set of executable client specific layout components which corresponds to the respective mask type in the abstract user interface description.

Further, the mask definition includes one or more abstract layout components ALC 1, ALC 2, . . . ALC y, which are required to enable the functions in compliance with the type of the mask. Examples for such abstract layout components are table rows, text descriptions, buttons, groupings, multi-selection boxes, dropdown lists, date fields or any other layout component necessary to implement the required function of the mask. The mask definition can also include attributes for defining in details the visual appearance of a layout component. For example, an attribute (attribute 1, attribute 2) for font settings or alignment of the layout component could be assigned to the respective section (ALC 1) in the mask definition. The information given in the mask definition is used for the initialization phase of the client specific user interface.

A mask definition can be localized which allows support of multi-language capabilities. That is, the layout for the same mask can be different for different languages. This may be implemented by having multiple abstract user interface descriptions for the same application stored on the server, where each version of the abstract user interface description correspond to localized version of the application in a respective language. The client device typically knows the language in which the user wants to interact with the application and can send a corresponding language attribute together with the application request to the server. The server will then select the appropriate localized version of the abstract user interface description and send it back to the requesting client device.

For each abstract layout component one or more data field references (data field 1, . . . , data field q) can be assigned. This allows an abstract object definition of a data object (MetaObject) associated with the mask. Such a definition may include a list of named fields with defined data types and object attributes. Object attributes, for example, may be used to indicate if a certain field is changeable or mandatory vs. optional. In other words, a MetaObject is a virtual object, which can be composed from different data sources. The MetaObject determines the mask context. For example, it may determine: which fields are visible in the application; which data records can be changed or deleted, perhaps dependent on the user's permissions; what is the search space for searches; which foreign keys can be used for sub-searches; which fields are mandatory for creating new data records, etc.

FIG. 4 illustrates a further part of the abstract user interface description 1101—the mask hierarchy 1101-2. The mask hierarchy can be used to define the sequential order of masks and further to define a navigation scheme for controlling the interaction of the user with the application.

The mask hierarchy can define relationships between different masks included in the abstract user interface description. The mask hierarchy can have multiple mask root nodes, e.g., mask1, mask 4. Such mask root nodes do not have a relationship but are independent starting points for using the application on the client. In one embodiment, each mask corresponding to a root node in the mask hierarchy may be directly accessible through a corresponding visual representation on the initial client specific user interface.

Sub-nodes in the mask hierarchy may indicate that the masks are visualized sequentially in the order of being listed in the mask hierarchy. That is, for the example of the mask hierarchy 1101-2 the user would have the option to start either with mask 1 or mask 4 once the user interface generation is finished. When starting with mask the next mask would be mask 2 followed by mask 3. When starting with mask 4, the user would also see mask 2 as the second mask when executing the application, but would then be followed by mask l and mask n.

The mask hierarchy can be implemented by using hierarchy references to establish the relationships between the various masks. For example, such a configuration has no direct parent-child relationships. Instead a table is used to establish the relationships between each mask and its parent mask. Masks not having a parent mask correspond to the root node masks explained before. Such a structure allows a high degree in mask handling flexibility and also allows easily reusing a certain mask at multiple places in the masks hierarchy, for example, simply by adding a second parent to mask 2 and reusing it in another context. Another advantage of this mask hierarchy data structure is the allowance of endless loops in terms of inheritance. This can be achieved by having multiple parent masks of a given mask.

For example, a first mask can follow a second mask which itself follows again the first mask. Therefore, an arbitrary number of levels in the interaction design of the application can be achieved, because the interaction design corresponds to the navigation scheme defined by the mask hierarchy.

Further, the possibility of having endless loops in the mask hierarchy allows the design of applications where the relationship between various application data is not known upfront. For example, the same mask may be used to handle different activities of the user in different application contexts. A user may see an overview of a certain customer visit and then have the possibility to further see upon user interaction a detailed report of the visit. In this example the corresponding mask has a reference to itself. In other words, it does not matter for the mask design whether a certain user activity has a follow-up activity or not. The mask can simply refer to itself and allow any number of follow-up activities associated with the same mask type.

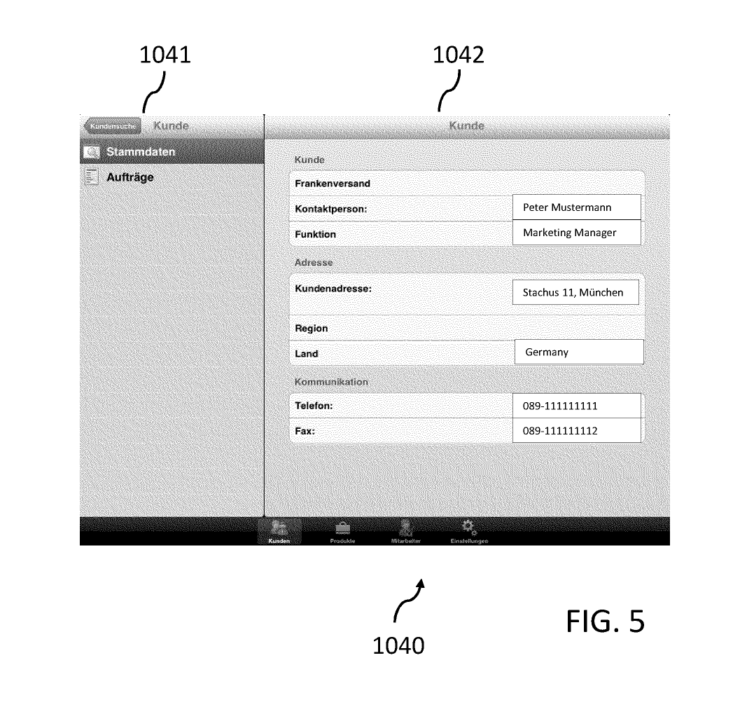

FIG. 5 is a client specific user interface example 1040 for a client device with split controller. Some mobile client devices with large display means are able to visualize multiple masks in parallel. The application can test at runtime if the client device executing the application is able to support this function.

The example shows a generated client specific user interface which displays at the same time a first mask 1041 related to a list of possible commands (Stammdaten, Aufträge) for a certain customer (Kunde) and a second mask 1042 showing the detailed view of master data (Stammdaten) for a customer (Kunde). Such type of mask visualization is supported for example by client devices running on the iOS® operating system of Apple®. The second mask 1042 may be of the type “detailed view” and includes eight field references being grouped into three field groups. The fields may be text fields, which are not editable and have certain style attributes for the visual appearance. In the mask hierarchy the second mask 1042 has the first mask 1041 as a parent. A split controller of the client device is able to split the client specific user interface display into two areas, where each area can display a separate mask. The order of the masks is determined by their relationship in the mask hierarchy. For instance, the rule can be that the parent is always visualized in the left part of the split user interface.

In other words, when the user performs an interaction requesting navigation inside the application, the device type is tested and if the device supports split controls a corresponding device specific mask layout component is generated according to the respective mask type and mask hierarchy. The device specific mask layout component is initialized according to the abstract user interface description information as explained previously. If available an application data object can be inherited from the parent mask (e.g., search result list detailed view). This for example may trigger a subsequent search (e.g., customer details customer orders). Finally, dependent on the device type (e.g., supporting split navigation) a correspondingly generated mask can be plugged into a superordinate controller of the user interface (e.g., a splitView).

The navigation bar at the bottom of the client specific user interface shows four representations of the mask root nodes of the mask hierarchy.

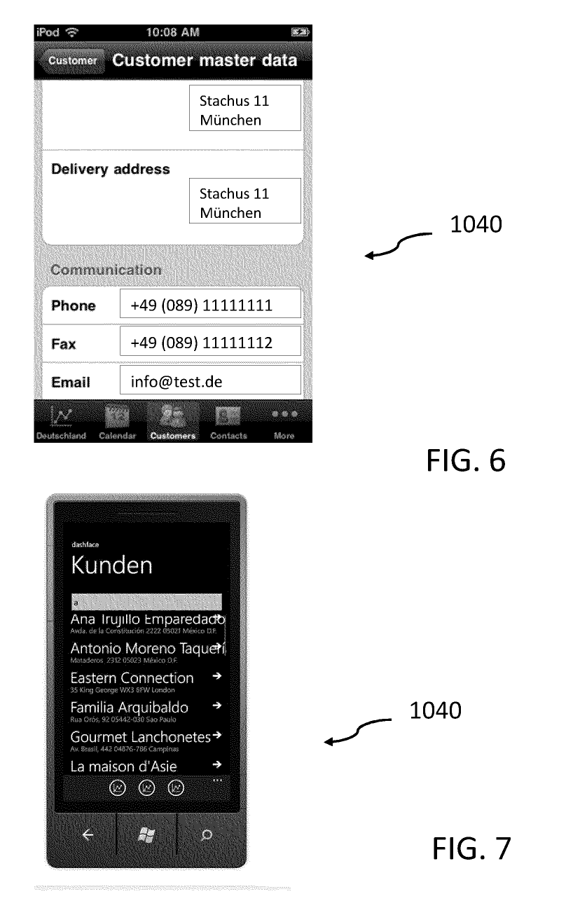

FIG. 6 is a client specific user interface example for a client device with a detailed view. That is, the mask type “detailed view” defines the general layout and various client specific layout components are included in the corresponding mask definition. A mask can be divided into different sections, wherein each section has a grouping function. Typically a mask will include at least one section. Inside one section a plurality of control elements can be supported. Examples of such control elements are rows for data, section headers for indicating groupings, icons for indicating mask root nodes, etc. In the example of FIG. 6 there are two sections (upper and lower section) with multiple rows, respectively. The detailed view allows the visualization of fields of a corresponding MetaObject. At runtime the fields referencing for example to the phone, Fax and Email application data are filled with the corresponding application data values received from the server.

FIG. 7 is a further client specific user interface example for a HTML5 client device. This client specific user interface shows a mask including a client specific layout component for a list of customers based for a client device running a HTML5 browser. Further, a client specific layout component for a search field is included above the list of customers. Three mask root node representations can be seen at the bottom bar.

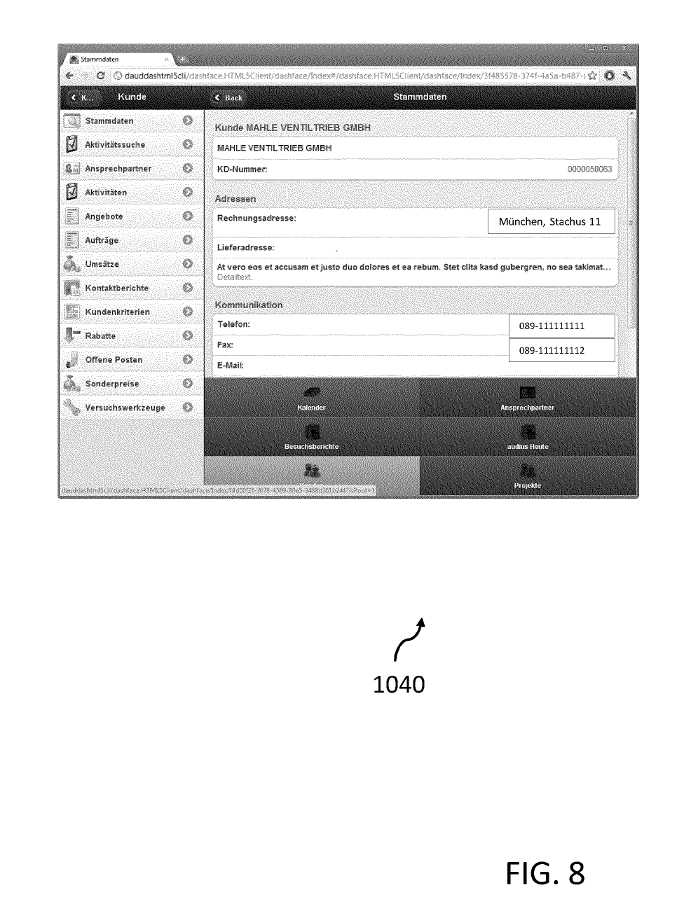

FIG. 8 is a further client specific user interface example for a Microsoft® Windows Phone 7 client device. This user interface is similar to the one described under FIG. 5. Again, two masks with a mask hierarchy relation are shown in parallel. The left hand mask (parent) shows a list of possible activities for clients. The right hand mask shows a detailed view for customer details including various groups of fields for application data. The mask root nodes in this example are displayed as six interaction buttons at the bottom of the right mask.

Embodiments of the invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program of claim 11, can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computing device. Generally, a processor will receive instructions and data from a read-only memory or a random access memory or both. The essential elements of a computer are at least one processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Such storage devices may also provisioned on demand and be accessible through the Internet (Cloud Computing). Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a cathode ray tube (CRT) or liquid crystal display (LCD) monitor, for displaying information to the user and an input device such as a keyboard, touchscreen or touchpad, a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (LAN) and a wide area network (WAN), e.g., the Internet or wireless LAN or telecommunication networks.

The computing system can include clients and servers. A client and server are generally remote from each other and typically interact through a communication network. The relationship of client and server arises by virtue of computer programs running on the respective computers and having a client-server relationship to each other.

1. A computer implemented method for graphical user interface generation at a client, comprising:
receiving from at least one server an abstract user interface description;
mapping the abstract user interface description to at least one executable client specific layout component;
generating a client specific user interface by instantiating the at least one executable client specific layout component;
receiving application data from the at least one server, wherein the application data is associated with the at least one executable client specific layout component, and wherein the application data is separate from the abstract user interface description; and
merging the client specific user interface with the associated application data.

2. The method of claim 1, further comprising:
receiving from the at least one server further application data being associated with the at least one executable client specific layout component; and
updating the client specific user interface 0040) with the further application data.

3. The method of claim 1, wherein the at least one executable client specific layout component is stored in a client specific layout component library of the client.

4. The method of claim 1, wherein the application data is stored in a local application database of the client.

5. The method of claim 1, wherein the abstract user interface description has at least one mask definition.

6. The method of claim 5, wherein the abstract user interface description has at least one object definition.

7. The method of claim 5, wherein the mask definition has at least one abstract layout component being associated with the at least one executable client specific layout component configured to enable the mapping.

8. The method of claim 7, wherein the object definition has at least one field reference assigned to at least one abstract layout component and being associated with the application data, the object definition being configured to enable the merging or updating.

9. The method of claim 5, wherein the abstract user interface description comprises a hierarchy defining a relationship between a plurality of masks.

10. The method of claim 9, wherein the hierarchy defines a sequential order of the masks and a navigation scheme for the client specific user interface.

11. A computer program product that when loaded into a memory of a computing device and executed by at least one processor of the computing device executes the following:
receiving from at least one server an abstract user interface description;
mapping the abstract user interface description to at least one executable client specific layout component;
generating a client specific user interface by instantiating the at least one executable client specific layout component;
receiving application data from the at least one server, wherein the application data is associated with the at least one executable client specific layout component, and wherein the application data is separate from the abstract user interface description; and
merging the client specific user interface with the associated application data.

12. A client computer for generating a client specific user interface description comprising:
an interface component configured to receive an abstract user interface description and further configured to separately receive application data being associated with at least one executable client specific layout component;
at least one memory component configured to store a client specific user interface component library comprising the at least one client specific layout component; and
at least one processor component configured:
to map the abstract user interface description to at least one executable client specific layout component;
to generate a client specific user interface by instantiating the at least one executable client specific layout component; and
to merge the client specific user interface with the associated application data.

13. The client computer of claim 12, wherein:
the interface component is further configured to receive further application data being associated with at least one executable client specific layout component; and
the at least one processor component is further configured to update the client specific user interface with the further application data.

14. The client computer of claim 12, wherein the at least one memory component further comprises a local application database configured to store the application data.

15. The client computer of claim 12, further comprising:
a display component configured to display the graphical user interface.

16. The computer program product of claim 11 further configured to execute:
receiving from the at least one server further application data being associated with the at least one executable client specific layout component; and
updating the client specific user interface with the further application data.

17. The computer program product of claim 11, wherein with the at least one executable client specific layout component is stored in a client specific layout component library of the client.

18. The computer program product of claim 11, wherein the abstract user interface description has at least one mask definition.

19. The computer program product of claim 18, wherein the abstract user interface description has at least one object definition.

20. The computer program product of claim 18, wherein the mask definition has at least one abstract layout component being associated with the at least one executable client specific layout component configured to enable the mapping.
